(19) United States
(12) Patent Application Publication
(10) Pub. No.: US 2015/0129726 A1
(43) Pub. Date: May 14, 2015

(54) MODULAR RETAINER FOR CABLES

(71) Applicant: Caterpillar Inc., Peoria, IL (US)

(72) Inventors: John A. Sherman, Peoria, IL (US); Joseph M. Spanier, Metamora, IL (US); Michael H. Noble, Peoria, IL (US); Lori Lents, San Diego, CA (US)

(73) Assignee: Caterpillar Inc., Peoria, IL (US)

(21) Appl. No.: 14/601,259

(22) Filed: Jan. 21, 2015

(51) Int. Cl. F16L 3/22; F16L 3/06

(52) U.S. Cl. CPC F16L 3/222; F16L 3/06
USPC 248/68.1

(57) ABSTRACT

A modular retainer assembly for electrical cables is disclosed. The modular retainer assembly includes a base having an upper surface and a lower surface. The upper and lower surfaces of the base define a thickness of the base therebetween. The modular retainer assembly also includes a plurality of divider walls projected outwardly from the upper surface of the base. Each divider wall of the plurality of divider walls define a channel disposed between the divider wall and an adjacent divider wall. Also, each divider wall has a curved profile along a length of each divider wall. Further, a cross section of each divider wall defines a top portion thickness and a bottom portion thickness, the bottom portion thickness of the divider wall being less than the top portion thickness of the divider wall measured at the cross section of the divider wall.

### TECHNICAL FIELD

The present disclosure relates to a cable mounting assembly, and more particularly to a modular retainer assembly for retention and organization of multiple electrical cables thereon.

### BACKGROUND

Electrical cables are cut and manually bundled for assembly and packaging into electrical cabinets. In some situations, the wire or cables are color coded or small labels are provided with each wire in the wire bundle for easy identification purpose. These bundles are typically not organized well and during service, technicians often need to dig through the wire bundle to identify labels and isolate certain desired wires. This results in time consuming and tedious work for technicians and generally leaves the wires in disarray. Moreover, the wires may become tangled and as a result additional time is required for the technician to sort, and organize and repackage the wires and fit the wires back in the electrical cabinet.

U.S. Pat. No. 6,801,704 discloses an optical fiber spice holder, including a base having an upper surface and a plurality of sidewalls coupled substantially orthogonal to the upper surface. Each pair of sidewalls of the plurality of sidewalls forms at least one channel therebetween. The at least one channel has a first radius sized to secure an optical fiber splice, and a plurality of channels are formed adjacent to each other.

### SUMMARY OF THE DISCLOSURE

In one aspect of the present disclosure, a modular retainer assembly for electrical cables is disclosed. The modular retainer assembly includes a base having an upper surface and a lower surface. The upper and lower surfaces of the base define a thickness of the base therebetween. The modular retainer assembly also includes a plurality of divider walls projected outwardly from the upper surface of the base. Each divider wall of the plurality of divider walls define a channel disposed between the divider wall and an adjacent divider wall. Also, each divider wall has a curved profile along a length of each divider wall. Further, a cross section of each divider wall defines a top portion thickness and a bottom portion thickness, the bottom portion thickness of the divider wall being less than the top portion thickness of the divider wall measured at the cross section of the divider wall

Other features and aspects of this disclosure will be apparent from the following description and the accompanying drawings.

### BRIEF DESCRIPTION OF THE DRAWINGS

FIG. 1 is a perspective view of an exemplary modular retainer assembly, according to one embodiment of the present disclosure;

FIG. 2 is a top view of the modular retainer assembly of FIG. 1 with cables provided in channels formed thereon; and

FIG. 3 is a perspective side view of the modular retainer assembly of FIG. 1.

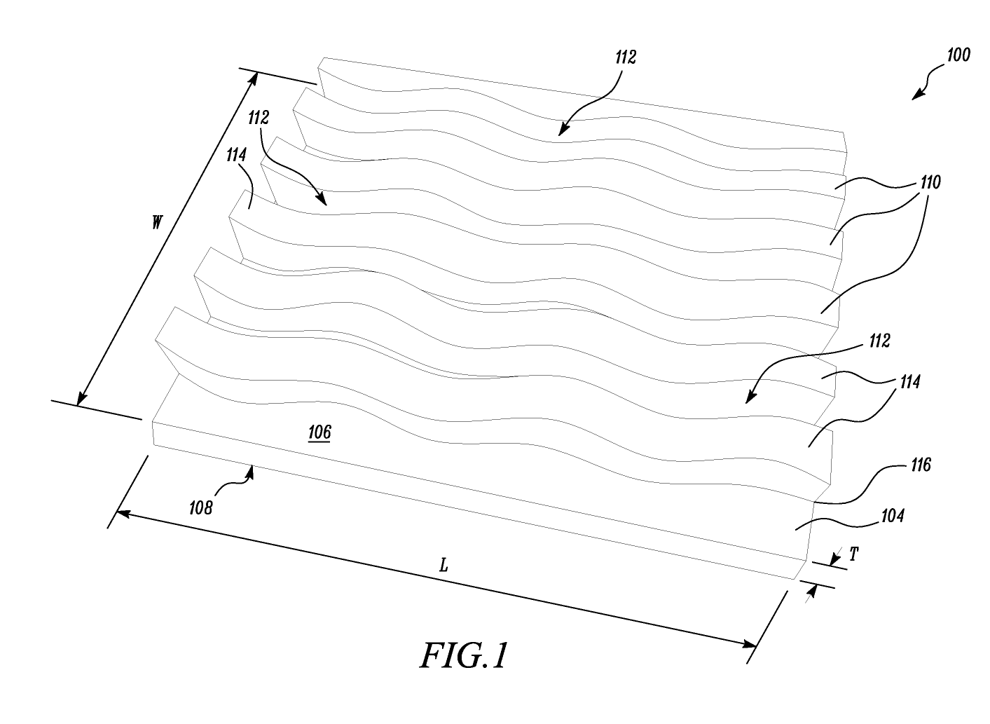

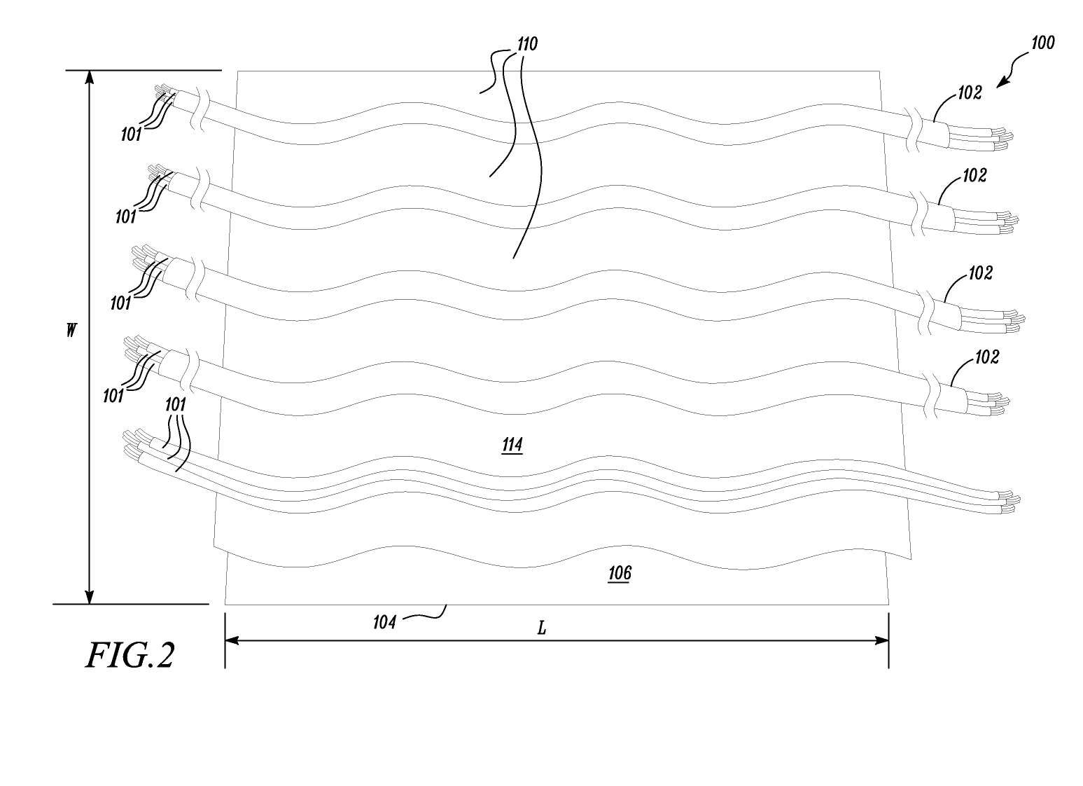

### DETAILED DESCRIPTION

Wherever possible, the same reference numbers will be used throughout the drawings to refer to the same or the like parts. FIG. 1 is a perspective view of an exemplary modular retainer assembly 100, according to one embodiment of the present disclosure. The modular retainer assembly 100 disclosed herein is configured to provide retention of electrical wires or cables 101, and the cables 101 may be bundled and protected by sheath or covering 102 (see FIG. 2). However, as is best shown at the bottom of FIG. 2, the cables 101 do not require to be bundled by the covering 102 and may often not be covered in order for service technicians to access and service one or more of the cables 101 which may be more individually accessible without the covering 102.

The modular retainer assembly 100 of the illustrated embodiment may be configured to organize and hold/retain various types of electrical cords, cables, conduits, and the like. In alternate embodiments, the modular retainer assembly 100 may also be used in electronic applications for holding optical splices or fibers, or in automotive applications. Further, the electrical cables 101 may be easily assembled and removed by hand and without tools from the modular retainer assembly 100, when required.

Referring to FIGS. 1 and 2, the modular retainer assembly 100 includes a base 104 which is substantially square shaped or alternatively, the base 104 may have other shapes such as rectangular, circular, oval, or any other shape known to those having ordinary skill in the art. The base 104 has an upper surface 106 and a lower surface 108. The upper and lower surfaces 106, 108 of the base 104 define a thickness “T” of the base 104 therebetween.

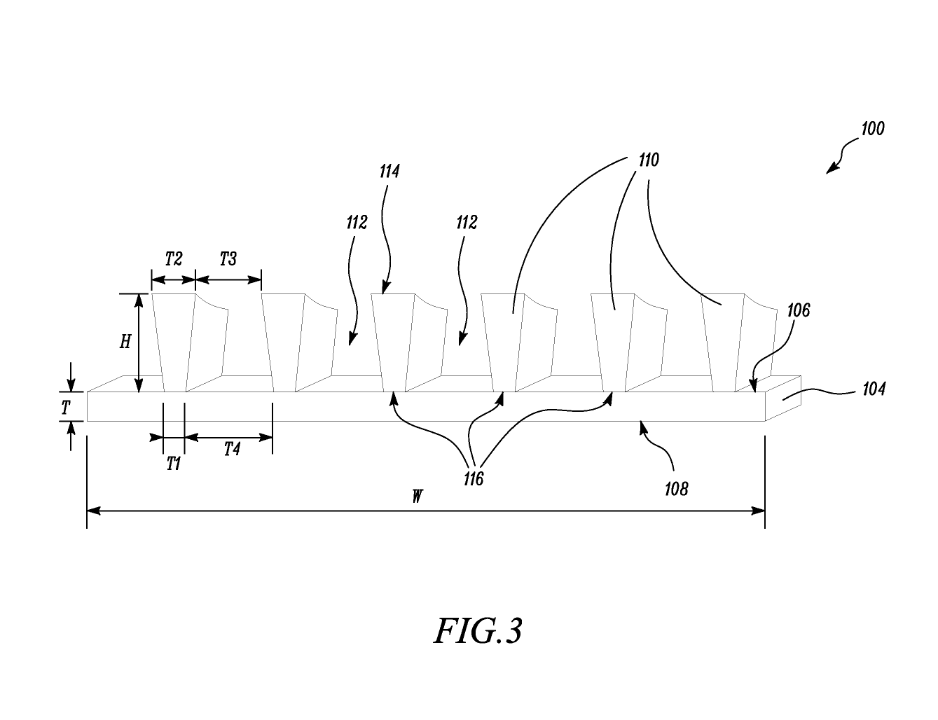

As best seen in FIGS. 2 and 3, the modular retainer assembly 100 has a plurality of divider walls 110 provided thereon. Each divider wall 110 is arranged in a uniform fashion with a generally uniform channel 112 between each adjacent divider wall 110. The plurality of divider walls 110 project outwardly from the upper surface 106 of the base 104 and defines a height “H”. Further, each divider wall 110 extends along an entire length “L” of the base 104. The divider walls 110 have a curved profile along a length of each divider wall 110

Further, each divider wall 110 is spaced apart from each adjacent divider wall 110 by a gap of width “T4” measured at an intersection of the divider wall 110 with the upper surface 106 of the base 104. An overall width of the modular retainer assembly 100 is illustrated as “W”. A cross-sectional shape of each channel 112 is best shown in FIG. 2, and it will be understood that juxtaposed divider walls 110 which define each channel 112 are generally tilted toward one another or canted at the top of each divider wall 110 to better retain the cables 101 within the channels 112. The electrical cables 101 are retained in the channels 112 (see FIG. 2). It will be understood that the channels 112 are curved to provide resistance between the cables 101 and the divider walls 110 such that if the cable 101 is pulled outwardly in a direction along a length of the channel 112 it will be less likely for the cable 101 to pull out based on the curved profile of the channel 112.

As shown in FIG. 3, since each channel 112 has the cross section which is generally canted inward at a top portion 114 of the divider wall 110, then each cross section for each divider wall 110 is tapered. More particularly, a thickness of the divider walls 110 tapers inward measured from the top portion 114 of the divider wall 110 towards a bottom portion 116 of the respective divider wall 110 which is attached to the base 104.

As shown in the accompanying figures, a bottom portion thickness “T1” of the divider walls 110 is lesser at the bottom portion 116, and increases upwardly along the height “H” of the divider wall 110. Thus, a top portion thickness “T2” of each of the divider wall 110 is comparatively greater at the top portion 114 as compared to the bottom portion thickness “T1” at the bottom portion 116 of the divider wall 110. Accordingly, the channels 112 so formed between the adjacent divider walls 110 has a gap of width “T3” at a top portion of the channels 112 which is comparatively lesser than a gap of width “T4” at a bottom portion of the channels 112.

Referring to FIG. 2, the electrical cables 101 are inserted within the channels 112 (see FIGS. 1 and 3) of the modular retainer assembly 100. The electrical cables 101 may be press fitted into the channels 112 of the modular retainer assembly 100. The electrical cables 101 are held therewithin via an interference/friction fit to retain the electrical cables 101 therein. The dimensions of the divider walls “T1” and “T2” and the corresponding dimensions of the channels “T3” and “T4” are so chosen based on a diameter of the electrical cables 101 to be retained within the modular retainer assembly 100. Further, the curved profile of the channels 112 additionally assist in retaining the electrical cable 101 within the channels 112. In some embodiments, the dimensions of the divider walls “T1” and “T2” and the corresponding dimensions of the channels “T3” and “T4” may vary along the width “W” of the base 104 of the modular retainer assembly 100 so that the electrical cable 101 of varying diameters may be accommodated within the modular retainer assembly 100.

Further, it should be noted that the number of the divider walls 110 and the corresponding channels 112 of the modular retainer assembly 100 shown in the accompanying figures are non-limiting, and may vary based on the application. Also, the length “L” and the width “W” of the base 104 may depend on the number of channels 112 required and also the number of electrical cables 101 that are to be retained within the modular retainer assembly 100.

The base 104 and the divider walls 110 of the modular retainer assembly 100 of the present disclosure may be fabricated from a material that is elastic or flexible in nature, so that the divider walls 110 may accommodate the electrical cable 101 therebetween. For example, the modular retainer assembly 100 may be made of a composition of one or more of a rubber, plastic, polypropylene, polymer, or any other flexible material.

It should be noted that the modular retainer assembly 100 is fabricated from a unitary piece of material. Alternatively, the modular retainer assembly 100 may be an assembly formed from a plurality of pieces. Further, the modular retainer assembly 100 is manufactured using any manufacturing process known to a person of ordinary skill in the art. In one embodiment, the modular retainer assembly 100 may be manufactured using additive manufacturing process, such as, a 3D printing process. Alternatively, the modular retainer assembly 100 may also be manufactured using any of the known subtractive manufacturing process.

The lower surface 108 of the modular retainer assembly 100 may be used for mounting the modular retainer assembly 100 onto a work surface (not shown). In one example, an adhesive may be provided on the lower surface 108 of the modular retainer assembly 100 for mounting purposes. Alternatively, a double sided bonding tape may also be provided on the lower surface 108 of the modular retainer assembly 100 for a mounting thereof. In yet another example, a zipper, straps or a hook and loop type fastener may also be used for mounting purpose. Further, the modular retainer assembly 100 may be fastened to the work surface by other conventional means, such as, for example, by rivets, screws, bolts, latches, or any other type of mechanical fasteners known to a person of ordinary skill in the art. The mounting of the modular retainer assembly 100 onto the work surface is not restricted hereto, any known means of mounting may also be used without limiting the scope of the present disclosure

### INDUSTRIAL APPLICABILITY

The present disclosure relates to the modular retainer assembly 100 for organizing and retaining the plurality of the electrical cable 101 therein. The modular retainer assembly 100 includes the plurality of divider walls 110, such that each of the adjacent divider walls 110 forms the channels 112 therebetween. The channels 112 so formed are configured to receive the electrical cable 101 therein. Based on the number of channels 112 so formed, multiple electrical cable 101 may be retained in the modular retainer assembly 100, such that the electrical cable 101 are arranged in an organized manner and also provide visual indication if a cable is missing or incorrectly sized. This may reduce the time associated with identification and arranging of the electrical cables 101.

The divider walls 110 of the modular retainer assembly 100 include the tapering configuration along the height “H” of the divider wall 110. Therefore, the channels 112 so formed have a shape such that the electrical cables 101 are held therein via the interference/friction fit. Further, the divider walls 110 and therefore the channels 112 of the modular retainer assembly 100 include the curved profile. Therefore, the shape of the divider walls 110 and the channels 112 may assist in the retention of the electrical cable 101, and reduce a likelihood of the electrical cable 101 to be accidentally pulled therefrom.

The electrical cable 101 may be single handedly pressure inserted within the channels 112 of the modular retainer assembly 100. Thus, the electrical cable 101 can be conveniently inserted within the channels 112 and removed therefrom. The modular retainer assembly 100 includes a compact structure and may be easily installed in small spaces. Further, a single modular retainer assembly may retain the plurality of the electrical cables 101 of various sizes in the channels 112 so formed.

In one example, the dimensions of the modular retainer assembly 100 may be varied to accommodate different sizes of the electrical cable 101, based on the application. Further, the modular retainer assembly 100 of the present disclosure may be made from an additive manufacturing process. In one example, a 3d printing process such as stereorlithography may be used to manufacture the modular retainer assembly 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A modular retainer assembly for retaining electrical cables, the modular retainer assembly comprising:
a base having an upper surface and a lower surface, the upper and lower surfaces of the base defining a thickness of the base therebetween; and
a plurality of divider walls projected outwardly from the upper surface of the base, each divider wall of the plurality of divider walls defining a channel disposed between the divider wall and an adjacent divider wall,
wherein each of the divider walls has a curved profile along the length of each divider wall,
wherein a cross section of each divider wall defines a top portion thickness and a bottom portion thickness, the bottom portion thickness of the divider wall being less than the top portion thickness of the divider wall measured at the cross section of the divider wall.
